(19) United States
(12) Patent Application Publication
(10) Pub. No.: US 2016/0275547 A1
(43) Pub. Date: Sep. 22, 2016

(54) Look Alike Advertising Modelling

(71) Applicant: Yieldmo, Inc., New York, NY (US)

(72) Inventors: Farid Jawde, Brooklyn, NY (US); John Todd Coleman, Brooklyn, NY (US)

(73) Assignee: Yieldmo, Inc., New York, NY (US)

(21) Appl. No.: 15/040,850

(22) Filed: Feb. 10, 2016

Related U.S. Application Data
(60) Provisional application No. 62/114,564, filed on Feb. 10, 2015.
(60) Provisional application No. 62/175,205, filed on Jun. 12, 2015.

(51) Int. Cl. G06Q 30/02; G06F 3/0482; G06F 3/0484

(52) U.S. Cl. CPC G06Q 30/0244; G06Q 30/0267; G06F 3/04842; G06F 3/0482

(57) ABSTRACT

An advertising optimization system and method is provided for use with advertisements on mobile devices. The advertisement format may be tested and modified for various optimization requirements and then reused for the same or different advertisements in locations which share some or all of the same attributes.

### CROSS REFERENCE TO RELATED APPLICATIONS

This application claims the benefit of the filing date of co-pending U.S. provisional patent application Nos. 62/114,564 entitled “Look Alike Advertising Modelling”, which was filed on Feb. 10, 2015 (the “'564 provisional”), by the same inventors of this application and 62/175,205 entitled “Device Linked Advertisement Format”, which was filed on Jun. 12, 2015 (the “'205 provisional), by one of the inventors of the '564 provisional). Both the '564 provisional and the '205 provisional are assigned to the same entity and are hereby incorporated by reference as if fully set forth herein.

### FIELD OF THE INVENTION

The technology of this disclosure relates generally to digital advertisements and more particularly but not exclusively to advertisement format optimization for a particular webpage and/or application and/or device and determining other webpages and/or applications with which to employ the same advertisement format.

### BACKGROUND OF THE INVENTION

With the proliferation of mobile network advertising and the competition for eyeballs, it is important to format advertisements for optimal effect.

It is widely known by marketers and publishers that the design and format of an advertisement dramatically impacts an overall effectiveness of that advertisement. However, in most cases, no single format is optimal for all locations where the advertisement can be displayed. For example, an optimal ad format on an iPhone might not be optimal on a Samsung Galaxy or on an iPad, etc., even if the advertisement is being displayed alongside the same content on each device. Similarly, an ad format can perform differently on the same device based on different content with which it is being displayed (e.g. an ad displayed next to a news story vs. an ad displayed on the homepage of a website vs. and ad displayed within an application).

As a result of this disparity, marketers and publishers have developed various ad formats that attempt to benefit from the variability in performance. However, conventional solutions fail to alter the ad format and design based on the intended location of the advertisement (e.g. the device on which it is displayed and/or the content with which it is displayed) or consumer of the advertisement. Instead, conventional formatting of advertisements is fixed when the advertisement is created. This problem has existed since the beginning of mobile advertising but has become exacerbated because of the plethora of devices and content being consumed on mobile devices.

Additionally, most advertisements are formatted for a particular webpage, or a particular location within a webpage. Conventional advertisements do not take advantage of the format optimization over various websites or devices and do not take advantage of the fact that a particular user may prefer or may react more favorably to a particular format on a particular device or over different devices.

It would thus be advantageous to create an advertisement optimization scheme that could be employed with advertisements on mobile devices which takes into consideration the device on which and/or the content with which the advertisement is being displayed and/or to whom the advertisement is being displayed and to be able to migrate that format to other content.

### BRIEF SUMMARY OF THE INVENTION

Many advantages of the disclosed technology will be determined and are attained by providing in a broad sense systems and methods for optimizing an advertisement format based on a display location and then migrating that optimized format to other locations. One or more configurations of the technology may provide an advertisement template for receiving advertising content (e.g. image, words, links, device type, etc.). The provided content can be altered to create various potential output formats for the same advertisement(s). One or more of the formatted advertisements is/are selected and tested (e.g. for device type, content, location on page, etc.) with a live audience. The results of the test are returned and may be employed to determine additional testing. Once an optimized format is determined, the same optimized format is employed for other locations sharing similar attributes.

One or more configurations of the technology includes a system for optimizing a digital advertisement format for display on a mobile device and reusing the optimized format. The system includes a processor based device which identifies advertisement placement locations and stores the placement locations. It is also configured to test an effectiveness of an advertisement format within at least one of the locations and determine an effectiveness of the format based on at least one predetermined objective. The system includes a memory for storing a result of the effectiveness test for at least one location and a search module configured to match the stored result with another of the stored locations.

One or more configurations of the technology includes a method for optimizing an advertisement format for an advertisement placement location and reusing the optimized format in another advertisement placement location. The method includes an advertisement server associating attributes with an advertisement placement location identifier. The advertisement server also associates attributes with another advertisement placement location identifier. At least one attribute is only associated with one of the location identifiers. The advertisement server stores the identifiers in memory and performs, for at least one advertisement format, optimization testing for an advertisement placement location associated with the advertisement placement location identifier to determine an optimized advertisement format. The advertisement server stores a result of the optimization testing, and using those results locates another location identifier having a sufficient number of the same attributes as the tested advertisement placement location identifier and employs the optimized advertisement format at a location associated with the located location identifier.

One or more configurations of the technology includes a method for optimizing a digital advertising format for a user of a mobile device and reusing the optimized format for additional advertisements on the user's mobile device. The method includes an ad server serving an advertisement for display on the mobile device. The advertisement includes an advertising format. The ad server creates an aesthetic preference profile for the mobile device by tracking the user's interaction(s) with the advertisement. The ad server receives profile criteria from the mobile device and stores at least some of the criteria in the aesthetic preference profile. The ad server uses the aesthetic preference profile to determine an effective advertising format for use with an additional advertisement, and serves the additional advertisement for display on the mobile device. The additional advertisement includes the effective advertising format.

The technology will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the technology, reference is made to the following description, taken in conjunction with the accompanying drawings, in which like reference characters refer to like parts throughout, and in which:

FIG. 1 is a an exemplary configuration in accordance with one or more features of the disclosed technology;

FIG. 2 is an illustration of an exemplary advertisement template in accordance with one or more features of the technology;

FIG. 3 is an illustration of an exemplary advertisement modified for various formats in accordance with one or more features of the technology;

FIG. 4 is a chart illustrating various exemplary test results in accordance with one or more features of the technology;

FIG. 5 is an illustration of an exemplary webpage showing potential add placements in accordance with one or more features of the technology; and

FIG. 6 is a block diagram illustrating operations of a digital ad server in accordance with one or more configurations of the disclosed technology.

The technology will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

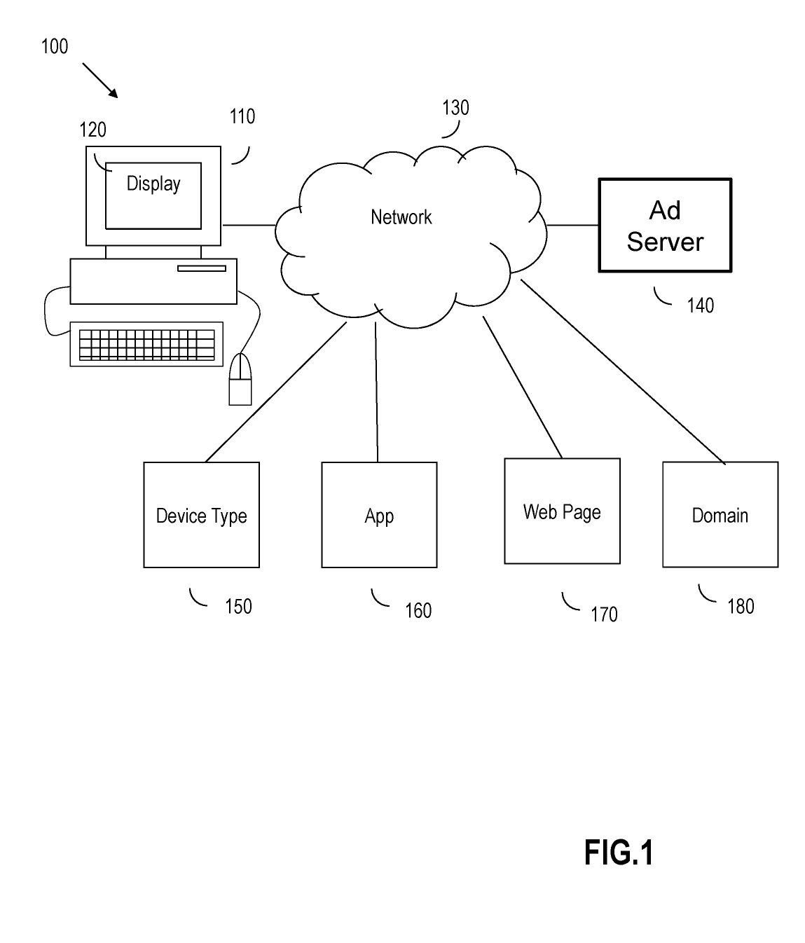

Referring to the drawings in detail wherein like reference numerals identify like elements throughout the various figures, there is illustrated in FIGS. 1-6 systems and methods for generating advertisement formats for optimization testing and determining different locations on which to employ the same advertisement format. By way of a non-limiting example, the systems and/or methods may determine one or more advertising formats that are the most effective or highly effective for a particular device/user and then employ that/those formats for future advertisements on that device or on a different device known to be employed by the same user. The advertisements may be employed in different types of mobile devices such as personal digital assistants (PDA), mobile phones, tablets, e-readers, portable game units, smart watches, etc. and on different types of web pages. Principles and operations of the new technology may be better understood with reference to the drawings and the accompanying description.

In co-pending patent application, entitled Advertising Format Optimization System, application Ser. No. 62/059,142 and assigned to the same owner as this application, mobile advertisement systems and methods for modifying advertisements for optimization testing are disclosed. That application is incorporated by reference as if fully set forth herein.

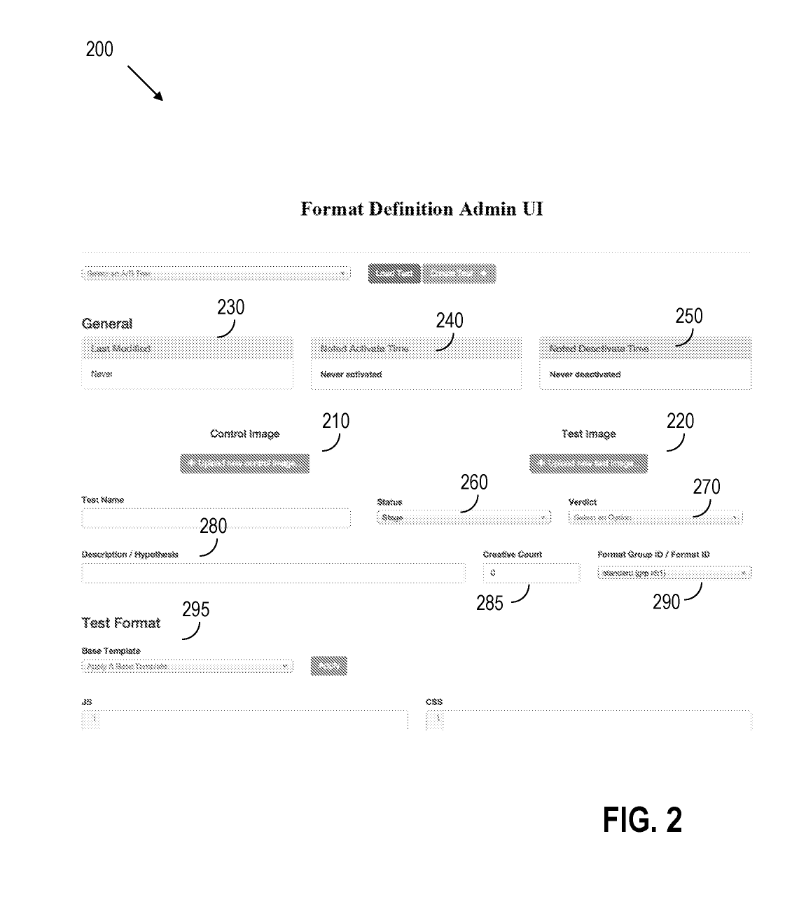

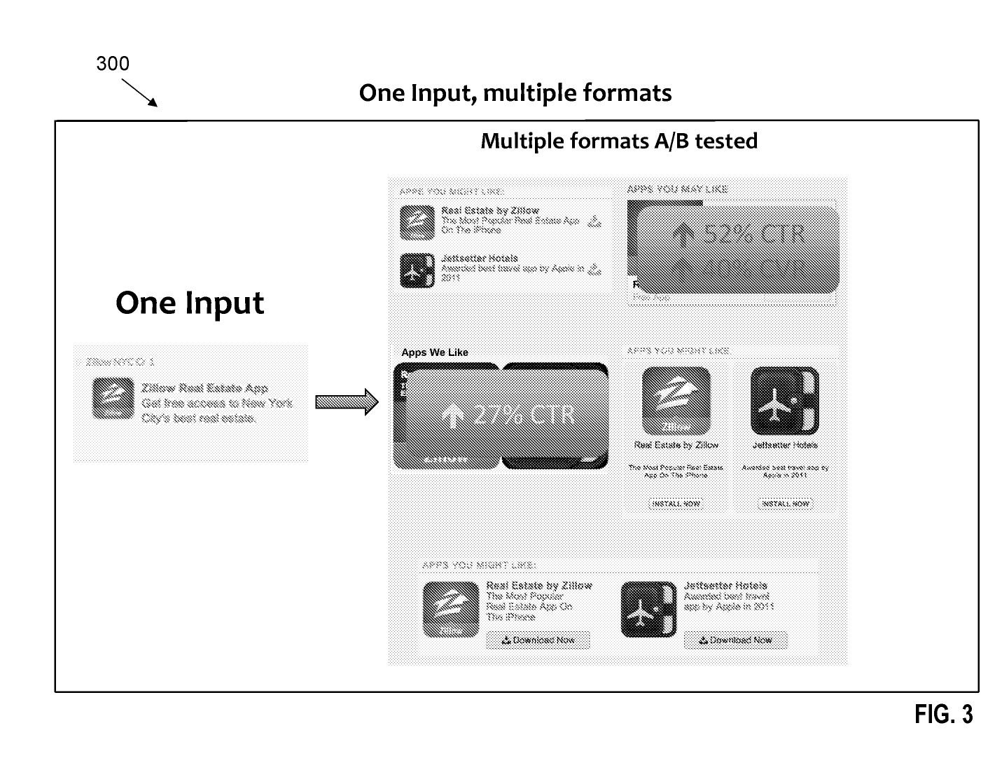

As illustrated in FIGS. 1-5, one or more configurations of the system 100 include a user interface 110 with a display 120. The user interface 110 which includes one or more of a mouse, keyboard, touch pad, touch screen, etc. is employed to populate a format template (FIG. 2) with general advertisement elements such as assets (e.g. image(s), words), advertisement status 230-250 (e.g. modified, never modified, activated, never activated, etc.), devices which support the advertisement format (e.g. could be general such as mobile phones, or a more specific such as iPhone 6, iPhone 6s, Kindle, Samsung Galaxy, etc.), a control image 210, a test image 220, and other testing instructions. Testing instructions may include parameters such as test status 260 (e.g. used to provision one or more tests. For example, a status of a test could be ‘Activated’, meaning the test is actively collecting data on the desired targets. Other sample status values are Paused, Concluded, and Staged. These statuses can be automatically updated by the system or manually controlled by a human, which gives more control in how tests are administered), verdict 270 (e.g. used to inform outcomes when not automatically derived. The verdict allows for the experimenter to add a conclusion to the test. For example, conclusion values could be Hypothesis Supported, Hypothesis rejected, Inconclusive, and rejected), hypothesis 280 (e.g. used for measurement and future predictive improvements. The Hypothesis entry allows for the system to track the success of the experiment. The Hypothesis is set before the experiment is activated, then upon conclusion, can be evaluated to determine the verdict), creative count 285 (e.g. used to define the maximum number of individual ads contained within a given test), format id 290 (e.g. used as a unique identifier for ad formats), and test format 295 (e.g. Allows for the creation of a test to be applied against the control. For example, if the control ad format is an image of fixed size, a test format could be created that employs a dynamic sized image that changes depending on the device size characteristics. This capability allows for the addition of computer code and/or template instructions to create the test format). The system employs the input items and generates various advertisement formats for the same advertisement (as illustrated in FIG. 3). It is also possible, though not required, that a user may be provided the option of inputting/creating a custom format. Those skilled in the art will recognize that additional or fewer input fields could be employed and still fall within a scope of the invention.

In operation of one or more configurations of the disclosed technology, a location is selected FIG. 1 (page 170, section of pages, application 160, domain 180, and/or device type 150, etc.) for the optimization system to test, and objectives are selected. Optimization objectives can vary. For example, in some cases, it may be desirable to optimize for user interaction with an ad (e.g. optimize for click-through rate (CTR)—Those skilled in the art will recognize that CTR is not limited to clicking the advertisement but instead refers to the more general concept of navigating to the destination associated with the advertisement—e.g. following the link). In other cases it may be desirable to optimize for sales for the advertisers (e.g. conversion rate) or time spent viewing the advertisement. In still other cases it may be desirable to optimize for one or more other aspects (including or not including the CTR or conversion rate). Those skilled in the art will recognize that these optimizations are not necessarily mutually exclusive. Additionally, regardless of the individual requirement, one or more of these non-selected optimizations may be performed and then stored for future reference and/or use. Once the formats, locations and objectives are selected the advertisement is uploaded to the ad server for testing on live traffic.

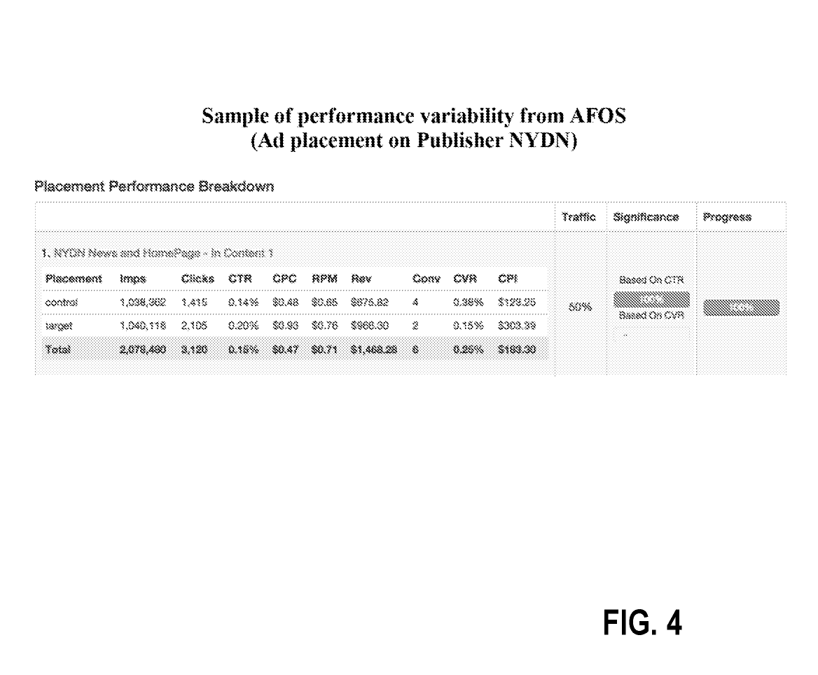

The test may be constrained by time, device type (general or specific), or location. The desired test criteria are/is selected, which can include ad formats, visual designs, and/or functional behaviors (e.g. swipe the screen vs tap the screen to invoke a response). The optimization system allocates each test criteria for exposure based on predefined desires, such as number of inputs tested and desired time to complete the test. The system runs one or more tests on live traffic to determine the results. The system and method for providing an advertisement to a mobile device is well known and thus will not be further described herein. These results FIG. 4 may be provided to the advertiser, to the publisher and/or employed to influence additional variations to test.

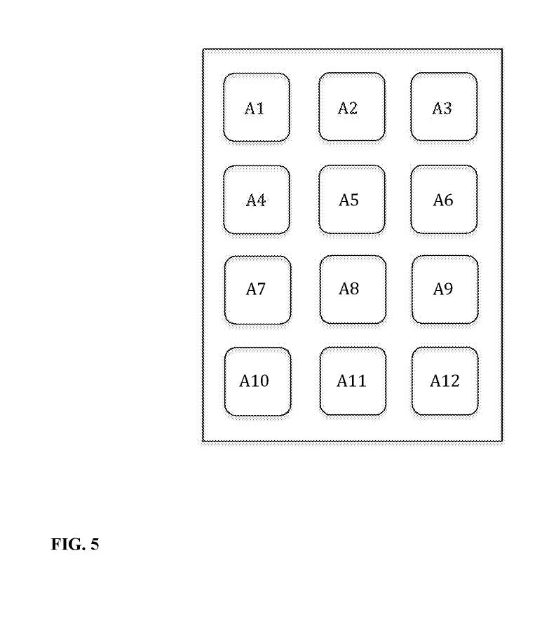

Once an advertisement format is considered optimized for a particular location, the format and the related information (e.g. device type, page location, page content, content format etc.) may be stored for future reference and/or use. For example, as illustrated in FIG. 5, each potential advertisement location A1-A12 within a particular web page or application may be provided with a unique identifier. Those skilled in the art will recognize that the identifier may not be unique in that it could share the same identifier with another location if that other location shares sufficient commonality with the initial location. The definition of sufficient in this situation is a design choice, but typically includes locations wherein the number of common attributes exceeds a threshold value. The unique identifier A1-A12 may include and/or be associated with information such as device type, page location, page content, page format, page color(s), font etc. Those skilled in the art will recognize that the identifier A1-A12 may include one or more of the above pieces of information and may include additional and/or different information related to the particular location and still fall within a scope of the invention. Those skilled in the art will also recognize that the number and location of the identifiers illustrated was done solely for ease of description and that the technology is not so limited. The number and location of the advertisement locations A1-AX may be greater than or fewer than the 12 illustrated and multiple identifiers could be associated with one or more of the individual locations. Additionally, locations A1-AX need not be limited to a single webpage. They can be associated with different webpages, with different devices, different apps, different domains, etc.

Using the above information, a search of webpages and/or applications and/or other landing pages and/or other devices may be performed for locations which would benefit from the saved advertisement formats and/or a search may be performed for advertisement formats that would be optimized for a particular location.

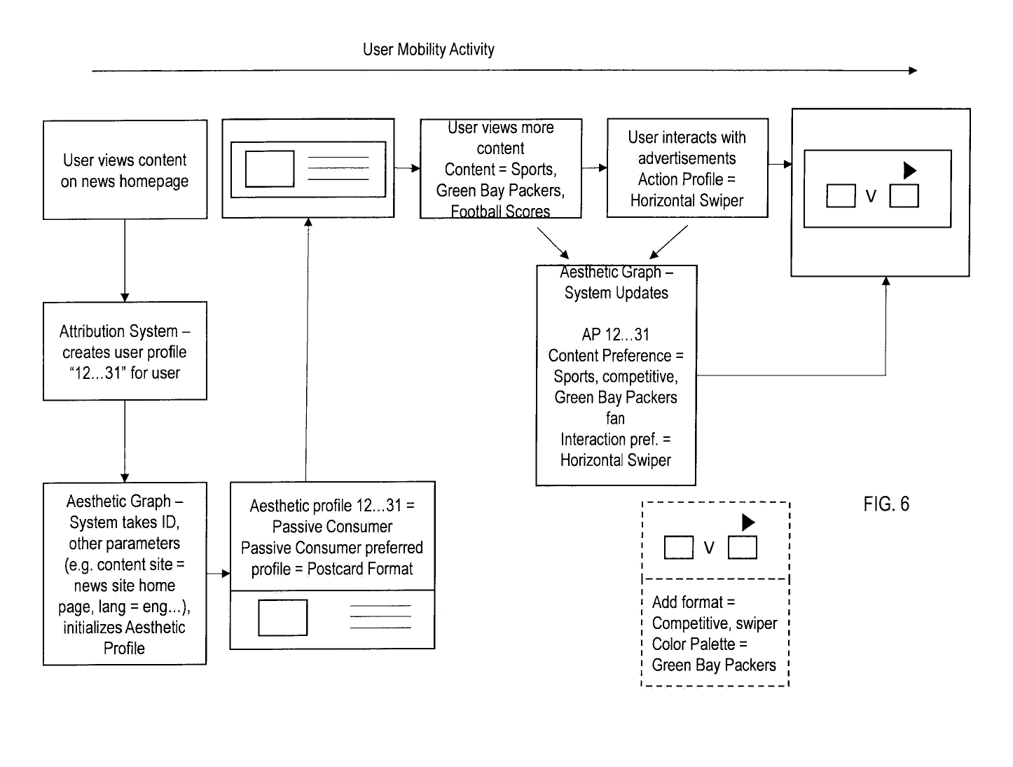

It is commonly understood that a particular mobile device is typically controlled by a single user. As such, one or more configurations of the technology may optimize advertising formats for that particular device/user. As illustrated in FIG. 6, the user may be tracked using cookies, device fingerprint matching or some other attribution technique (e.g. Google Install Referrer; Identifier Matching, Open URL with Click ID etc.). The device/user is tracked to determine which websites are accessed, which applications are accessed and/or downloaded, and which advertisement formats are selected on that user's device. As with the above description, one or more locations may be selected (page, section of pages, domain, application, etc.) for the system to test a particular advertising format, and objectives are selected. Optimization objectives can vary. For example, in some cases, it may be desirable to optimize for user interaction with an ad (e.g. optimize for CTR). In other cases it may be desirable to optimize for sales for the advertisers (e.g. conversion rate) or time spent viewing the advertisement. In still other cases it may be desirable to optimize for one or more other aspects (including or not including the CTR or conversion rate). Some additional aspects may include ad formats, visual designs, and/or functional behaviors (e.g. swipe the screen vs tap the screen to invoke a response). Those skilled in the art will recognize that these optimizations are not necessarily mutually exclusive.

Once an ad is served to a user/device, one or more profile(s) of aesthetic preferences is/are constructed. Profiles may be distinguished by viewing location (e.g. FIG. 5), by content (e.g. sports, world news, games, etc.), by time (day of the week, hour of the day), by geography, etc., by advertisement type (e.g. multimedia advertisements, still images, video, etc.). Initialization of the user's aesthetic preferences is derived from other signals present in the ad request (such as those discussed above). These can include device, language settings, carrier specifics, geography, publisher/content type origin, and other criteria. Subsequent ads served to this user allow for refinement of the aesthetic preference based on signals from more observations, which can include additional parameters like other content/publishers viewed as well as interactions and behaviors with the advertisement and content. For example, clicks, swipes, plays or extended time spent on a particular ad format will inform the user's aesthetic preference profile. Similarly, a lack of interaction to an aesthetic treatment can also inform an aesthetic presence profile, but in an opposite way as it is usually the case that the format was not agreeable to the users preferred experience.

Once the user's aesthetic profile(s) is/are sufficiently created, most or all future advertisements, for at least a certain period of time or for a certain number of advertisements published to that user, will use aesthetics which have been determined to be the most effective or at least sufficiently effective for that user. Those skilled in the art will recognize that there could be a single sufficient advertisement format or multiple sufficient advertisement formats and the multiple advertisement formats may be cycled, randomly utilized or utilized based on predetermined criteria (e.g. one or more certain format(s) may be employed with all sports related content, while one or more format(s) may be employed for all games, etc.). Additionally there may be overlap in the formats (e.g. there may be 2 formats that are optimal for sports and 2 formats that are optimal for games and 1 of the formats is common to both).

The aesthetic profile may be constantly updated, only updated for a particular amount of time and/or for a particular number of advertisements. After a profile has not been updated for a certain number of advertisements and/or for a certain amount of time the system may begin to update the profile again depending on a design choice of the system.

Using the above information it may be determined which advertising format(s) most often meet the respective objectives described above. That information may be used to select a single advertising format to use on that device for all advertisements, to select an advertising format based on a particular objective, to select a group of formats to choose from for that particular device, or to select a particular format based on the content with which the advertisement is being displayed. This selection may be employed for a particular time period (e.g. for a day, a week, a month, a year or some other period of time) and/or it may be employed until its effectiveness falls below some threshold.

Having thus described preferred features of the new technology, advantages can be appreciated. Variations from the described configurations exist without departing from the scope of the claims. Thus it is seen that an advertisement system and method for testing various aspects of the advertisement for optimizing for selected preferences are provided. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the technology as defined by the claims. Other aspects, advantages, and modifications are considered to be within the scope of the following claims. The claims presented are representative of the new technology disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the invention. The computer system may be any suitable apparatus, system or device, electronic, optical, or a combination thereof. For example, the computer system may be a programmable data processing apparatus, a computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A system for optimizing a digital advertisement format for display on a mobile device and reusing the optimized format, the system comprising:
a processor based device which identifies a plurality of advertisement placement locations and stores said plurality of placement locations,
said processor based device configured to test an effectiveness of an advertisement format within at least one of said locations and determine an effectiveness of said format based on at least one predetermined objective;
a memory for storing a result of said effectiveness test for said at least one of said locations; and,
a search module configured to match said stored result with another of said stored locations.

2. The system according to claim 1 further including said processor based device configured to serve an advertisement using said advertisement format at said another of said stored locations.

3. The system according to claim 2 wherein said advertisement is an advertisement that was tested in said effectiveness test.

4. The system according to claim 2 wherein said advertisement is an advertisement that was not tested in said effectiveness test.

5. The system according to claim 1 wherein said at least one objective is an objective selected from the list objectives consisting of click click-through rate (CTR), conversion rate, and an amount of time the advertisement is displayed.

6. The system according to claim 1 wherein said plurality of locations include one or more locations selected from the list of locations consisting of a page, a section of a page, a domain, and a device type.

7. The system according to claim 1 wherein said processor based device is an advertisement server.

8. The system according to claim 1 wherein said result includes at least one result from the selection of results consisting of a page type, a location within a page, a page content, a content format, and a device type.

9. The system according to claim 1 further comprising said processor based device configured to test an effectiveness of a plurality of advertisement formats within said at least one of said locations and determine which of said formats is the most effective based on said at least one predetermined objective.

10. The system according to claim 9 wherein said result includes said most effective format.

11. The system according to claim 9 wherein said memory is configured to store at least two of said formats and wherein said search module is configured to only match said most effective format with another of said stored locations.

12. A method for optimizing an advertisement format for an advertisement placement location and reusing the optimized format in an another advertisement placement location, the method comprising:
an advertisement server associating a plurality of attributes with an advertisement placement location identifier;
said advertisement server associating another plurality of attributes with another advertisement placement location identifier; wherein said plurality of attributes and said another plurality of attributes include at least one attribute that is only associated with one of said location identifier and said another location identifier;
said advertisement server storing said identifiers in memory;
said advertisement server performing, for at least one advertisement format, optimization testing for an advertisement placement location associated with said advertisement placement location identifier to determine an optimized advertisement format;
said advertisement server storing a result of said optimization testing; and
said advertisement server locating yet another location identifier having a sufficient number of same attributes as said advertisement placement location identifier and employing said optimized advertisement format at a location associated with said yet another location identifier.

13. The method according to claim 12 wherein said optimization testing includes at least one objective selected from the group of objectives consisting of click-through rate (CTR), conversion rate, and an amount of time the advertisement is displayed.

14. The method according to claim 12 wherein each of said advertisement placement location and said yet another advertisement placement location is respectively selected from the list of locations consisting of a page, a section of a page, a domain, and a device type.

15. The method according to claim 12 wherein said result includes at least one result from the selection of results consisting of a page type, a location within a page, a page content, a content format, and a device type.

16. The method according to claim 15 wherein said result further includes said at least one advertisement format.

17. The method according to claim 13 further including said advertisement server performing, for a plurality of advertisement formats, optimization testing for said advertisement placement location and determining which of said plurality of formats is most effective based on said at least one objective.

18. The method according to claim 17 wherein said result includes said most effective format.

19. The method according to claim 17 further including said memory storing at least two of said advertisement formats.

20. The method according to claim 12 wherein said sufficient number of same attributes is determined by comparing the number of same attributes to a threshold.

21. A method for optimizing a digital advertising format for a user of a mobile device and reusing the optimized format for additional advertisements on said device, the method comprising:
an ad server serving an advertisement for display on said mobile device;
wherein said advertisement includes an advertising format;
said ad server creating an aesthetic preference profile for said device by tracking a user's interaction with said advertisement;
said ad server receiving a plurality of profile criteria from said mobile device and storing at least some of said criteria in said aesthetic preference profile;
said ad server using said aesthetic preference profile to determine an effective advertising format for use with an additional advertisement; and
said ad server serving said additional advertisement for display on said mobile device wherein said additional advertisement includes said effective advertising format.

22. The method according to claim 21 further comprising said ad server creating a plurality of aesthetic preference profiles; and wherein said effective advertisement format is derived from at least one of said plurality of aesthetic preference profiles.

23. The method according to claim 21 wherein said plurality of aesthetic preference profiles are differentiated by at least one of viewing location, content, time, geography, and advertisement type.

24. The method according to claim 21 further comprising said ad server serving another advertisement for display on said mobile device; wherein said another advertisement includes another advertising format; said ad server receiving additional profile criteria from said mobile device and refining said aesthetic profile based on said additional profile criteria.

25. The method according to claim 21 wherein said ad server tracks said user using at least one attribution technique.

26. The method according to claim 25 further comprising said ad server determining that said user is operating a processor based device other than said mobile device, said ad server serving said additional advertisement for display on said processor based device other than said mobile device wherein said additional advertisement includes said effective advertising format.
